(19) United States
(12) Patent Application Publication
(10) Pub. No.: US 2008/0062465 A1
(43) Pub. Date: Mar. 13, 2008

(54) IMAGE FORMING APPARATUS

(76) Inventor: Takayuki SUZUKI, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/839,300

(22) Filed: Aug. 15, 2007

(30) Foreign Application Priority Data
Sep. 11, 2006 (JP) JP2006-245363

(51) Int. Cl. G06K 1/00

(52) U.S. Cl. 358/1.18

(57) ABSTRACT

An image forming apparatus includes an image forming section which forms an image based on image information; an HDD which stores the image information; a control section which measures continuos operation time in which the HDD operates continuously, and calculates residual lifetime of the HDD based on the continuos operation time having been measured and information of shortened lifetime caused by continuous operation; and an alarming section which issues an alarm based on the residual lifetime of the HDD.

### CROSS REFERENCE TO RELATED APPLICATION

The present application is based on Japanese Patent Application No. 2006-245363 filed with Japanese Patent Office on Sep. 11, 2006, the entire content of which is hereby incorporated by reference.

### BACKGROUND OF THE INVENTION

1. Field of Technology

The present invention relates to an image forming apparatus particularly to an image forming apparatus provided with an HDD.

2. Description of Related Art

An HDD (hard disk drive) has been used as a storage medium of various types of equipment in the conventional art. In the HDD, a magnetic disk is rotated by a motor and data is written and read by a magnetic head.

The HDD is equipped with a bearing to rotate the magnetic disk with a motor, and therefore, the bearing tends to wear with the rotation of the magnetic disk. Thus, the HDD is regarded as one of the consumables and a problem may occur caused by the wear of the bearing.

Normally, the HDD is guaranteed for a lifetime of 20,000 hours for example in cases where the operation of less than eight hours is repeated.

Regarding lifetime management system, Unexamined Japanese Patent Application Publication No. 2000-322811 proposes an HDD apparatus, wherein a motor drive time period during which data R/W (Read/Write) is conducted, and another motor drive time period from the time when R/W execution stop instruction from the higher-level apparatus to the time of power OFF are accumulated. The accumulated time period is recorded as an accumulated time during which power supply is conducted from a power control circuit. Then the accumulated time is compared with a predetermined lifetime, and when the accumulated time surpasses the predetermined lifetime, an indication of the expiration of lifetime is displayed on its display section.

In the lifetime management system proposed in Unexamined Japanese Patent Application Publication No. 2000-322811, the apparatus power-on time are accumulated regardless of continuous/intermittent operations, and an alarm is issued according to the accumulated apparatus power-on time.

Thus, the same period power-on time when the short-term intermittent operation is repeated has been counted as the same as the same period power-on time when the long-term continuous operation has been repeated.

As described above, the HDD is guaranteed for a lifetime of 20,000 hours when the operation of less than eight hours is repeated. However, the parts such as a motor or bearing in the HDD are deteriorated by the heat generation resulting from continuous operation. Accordingly, a trouble may occur before the operation time reaches the guaranteed operation time as the lifetime, depending on the operation conditions.

Thus, the inventors of the present invention have found out that accurate or safety-oriented lifetime prediction cannot be achieved by the method of the alarm being issued based on the accumulated operation time as described in Unexamined Japanese Patent Application Publication No. 2000-322811, as described above.

Further, if the HDD is frequently started-up and stopped, the processing time needed for the start-up and stop of the motor, forward and backward movement of the magnetic head, and loading, is increased; and the wear of the parts is increased resulting from such operations. Therefore, normally the HDD does not stop for a predetermined time even after the termination of access.

In an image forming apparatus that has to receive frequently a large amount of image data transmitted from a plurality of transmitters, for example, the image data is frequently stored in the HDD, and the HDD is not stopped every time. This may prolong the continuous operation time of the HDD.

A trouble may occur before the anticipated time because of such an extension of continuous operation time.

To solve the aforementioned problem, the object of the present invention is to achieve accurate prediction of the HDD lifetime, thereby allowing the HDD to be replaced before the occurrence of a problem, and reducing the loss that may be caused by a sudden stop of the image forming apparatus.

The operation of an HDD refers to the rotation of a motor that drives a magnetic disk for recording information. The continuous operation refers to the continuous operation of the motor without being stopped. Residual lifetime refers to the lifetime remaining at a certain time.

### SUMMARY

An image forming apparatus reflecting one aspect of the present invention to achieve the aforementioned object includes: an image forming section which forms an image based on image information; an HDD which stores the image information; a control section which measures continuous operation time in which the HDD operates continuously, and calculates residual lifetime of the HDD based on the continuous operation time having been measured and information of shortened lifetime caused by continuous operation; and an alarming section which issues an alarm based on the residual lifetime of the HDD.

In the image forming apparatus described above, the control section calculates the residual lifetime by utilizing a formula of:

T=TL−Σₙ₌₁ⁿ(tₙ×αₙ)

where, T is residual lifetime (hours), TL is HDD lifetime (hours), n is number of times of a plurality of continuous operations of the HDD, tₙ is continuous operation time for each of “n” times continuous operations (hours), and αₙ is a lifetime shortened factor for each of “n” times continuous operations.

An image forming apparatus reflecting another aspect of the present invention includes: an image forming section which forms an image based on image information; an HDD which stores the image information; a cooling device which cools the HDD; a control section which measures continuous operation time in which the HDD operates continuously, non-cooling time during which the cooling device does not cool the HDD in the continuous operation time, and cooling time during which the cooling device cools the HDD in the continuous operation time, which obtains non-cooling time shortened lifetime information corresponding to the non-cooling time, and cooling time shortened lifetime information corresponding to the cooling time, and which calculates residual lifetime of the HDD based on the non-cooling time, non-cooling time shortened lifetime information, cooling time, and cooling time shortened lifetime information; and an alarming section which issues an alarm based on the calculated residual lifetime of the HDD.

In the image forming apparatus described above, the control section calculates the residual lifetime by utilizing a formula of:

T=TL−Σₙ₌₁ⁿ{(t1ₙ×α1ₙ)+(t2ₙ×β1ₙ)}

where, T is the residual lifetime (hours), TL is HDD lifetime (hours), n is number of times of a plurality of continuous operations of the HDD, t1ₙ is each non-cooling time in each of “n” times continuous operations (hours), α1ₙ is a lifetime shortened factor corresponding to the non-cooling time t1ₙ, t2ₙ is each cooling time in each of “n” times continuous operations (hours), and β1ₙ is a lifetime shortened factor corresponding to the cooling time t2ₙ.

### BRIEF DESCRIPTION OF THE DRAWING

These and other objects, advantages and features of the invention will become apparent from the following description thereof taken in conjunction with the accompanying drawings in which:

FIG. 1 is a conceptual diagram representing an example of the positional relation between an HDD and a fan;

FIG. 2 is a block diagram showing an multi-function peripheral (MFP);

FIG. 3 is a conceptual diagram showing the shortened lifetime information table describing the shortened lifetime information with respect to the HDD continuous operation time;

FIG. 4 is a drawing representing an example of the HDD operating conditions;

FIG. 5 is a conceptual diagram showing the shortened lifetime information table describing the shortened lifetime information with respect to the continuous operation time with consideration given to cooling of the HDD;

FIG. 6 is a flow chart representing the method of issuing an alarm relating to the HDD lifetime in the image forming apparatus; and

FIG. 7 is a drawing showing an example of an alarm about the HDD lifetime.

### DETAILED DESCRIPTION OF THE PREFERRED EMBODIMENT

The following describes the best mode of embodiment of the present invention with reference to drawings. It is to be expressly understood, however, that the present invention is not restricted thereto. The present invention can be embodied in a great number of variations with appropriate modification or additions, without departing from the technological concept and scope of the invention claimed.

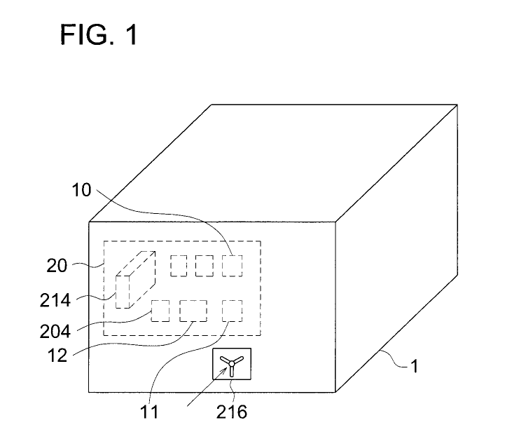

FIG. 1 is a conceptual diagram representing an example of the positional relation between the HDD and a fan.

An HDD 214 and control board 20 are incorporated in the Multi-Function Peripheral (MFP) 1 (the image forming apparatus will hereinafter be referred to as “MFP”) as an example of the image forming apparatus. The control board 20 is provided with a CPU (Central Processing Unit) 10, ROM (Read Only Memory) 12, battery-backed-up RAM (Random Access Memory) 11, and HDD controller 204 for HDD control.

A cooling fan 216 is arranged in the vicinity of the control board 20 and HDD 214 so that the external air is sucked to ventilate the interior of the MFP 1. At the same time, the control board 20 and HDD 214 are cooled. It should be noted that, if the cooling fan 216 has a sufficient ventilation capability and control board 20 and HDD 214 can be cooled, it is possible to adopt the method of exhaust ventilation. Further, the HDD 214 can be installed preferably at a place where the HDD is directly exposed to wind from the cooling fan 216.

There is no restriction to the type of the image forming apparatus if an image can be formed. It is exemplified by an MFP, a printer, a FAX machine or a copier.

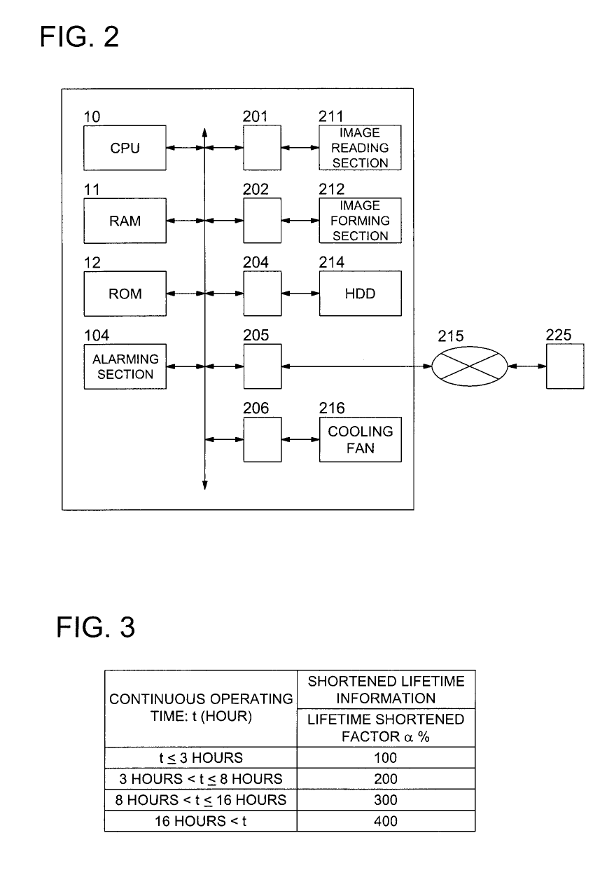

FIG. 2 is a block diagram showing a control function of the MFP.

In the MFP 1, an alarming section 104, image reading section controller 201, image forming section controller 202, network controller 205 and cooling fan controller 206 are connected with one another through a bus, in addition to the aforementioned CPU 10, ROM 12, RAM 11, and HDD controller 204.

The control program for controlling the entire MFP stored in the ROM 12 is read onto the RAM 11, and various types of control (to be described later) are executed by the CPU 10.

Various forms of data are temporarily stored in the battery-backed-up RAM 11.

The control program for controlling the entire MFP 1 and the HDD shortened lifetime information (to be described later) are stored in the ROM 12 in advance.

The image reading section controller 201 controls the image reading section 211 that reads a document image under the control of the CPU 10. The image information obtained from the image reading section 211 is stored in the HDD 214. The image reading section 211 is also employed to read the document image when using the FAX function.

The image forming section controller 202 controls the image forming section 212 under the control of CPU 10. The image forming section controller 202 reads out the image information stored in the HDD 214 so that the image is printed on a recording medium by the image forming section 212 based on the image information. The image forming section 212 is also used to print out the received image when the FAX function is employed.

The network controller 205 as a means of communication is linked with the equipment 225 capable of sending and receiving the image information via the Internet or LAN (Local Area Network) 215 or communication line, and is used to send and receive the image information. The received image information is stored in the RAM 11. The image information stored in the RAM 11 is read by the network controller 205, whereby this image information is sent out. The network controller 205 is also used to send and receive the image information when the FAX function is employed.

When storing or reading the image information, the CPU 10 measures the continuous operation time (from the time of the access of HDD 214 to the time when a predetermined time elapsed after the completion of access) when the HDD 214 operates on a continuous basis.

In the MFP 1 having the aforementioned structure, to get the shortened lifetime information by the continuous operation of the HDD 214, the CPU 10 reads from the ROM 12 the shortened lifetime information table containing the description of the lifetime shortened factor corresponding to the continuous operation time, whereby the lifetime shortened factor α corresponding to the continuous operation time is obtained.

The CPU 10 calculates the residual lifetime of the HDD 214 according to the lifetime shortened factor α and continuous operation time.

It is also possible to arrange such a configuration that, instead of the control of CPU 10, the special-purpose hardware for calculation of residual lifetime is separately installed, whereby the residual lifetime is calculated.

Based on the residual lifetime of the HDD having been calculated under the CPU 10, the alarming section 104 issues an alarm about the lifetime of the HDD 214 when the residual lifetime has reduced to zero or less than zero hour (0 or negative value). A liquid crystal display or buzzer is used as an alarming section 104.

Under the control of CPU 10, the HDD controller 204 ensures that the image information having been received through the network controller 205 and the image information read by the image reading section 211 is stored into the HDD 214, and image information having been stored is outputted from the HDD 214 when needed.

The cooling fan controller 203 turns on or off the cooling fan 216 under the control of CPU 10 when needed, whereby the interior of the MFP 1 and HDD 214 are cooled.

FIG. 3 is a conceptual diagram showing the shortened lifetime information table describing the shortened lifetime information with respect to the HDD continuous operation time.

The lifetime shortened factor is defined as a lifetime shortening acceleration factor that speeds up the shortening of the lifetime.

The shortened lifetime information table (FIG. 3) is stored in the ROM 12. For example, the lifetime shortened factor is 4 when an HDD having a lifetime of 20,000 hours is continuously operated for 16 hours or more without interruption while the cooling fan is kept turned off without being cooled. If the HDD having a lifetime of 20,000 hours is kept used under the operating conditions, the residual lifetime will be zero (0) 5,000 hours after the start of operation.

The residual lifetime can be calculated by the following formula, assuming that residual lifetime is T (hours) (in the case of continuous operation, residual lifetime when power is turned on), HDD lifetime is TL (hours), the number of times of a plurality of continuous operations is n, the continuous operation time for each of “n” times continuous operations is tn (hours), and the lifetime shortened factor for each of “n” times continuous operations is αₙ.

Residual lifetime T=lifetime TL−Σₙ₌₁ⁿ(continuous operation time tₙ×lifetime shortened factor αₙ)

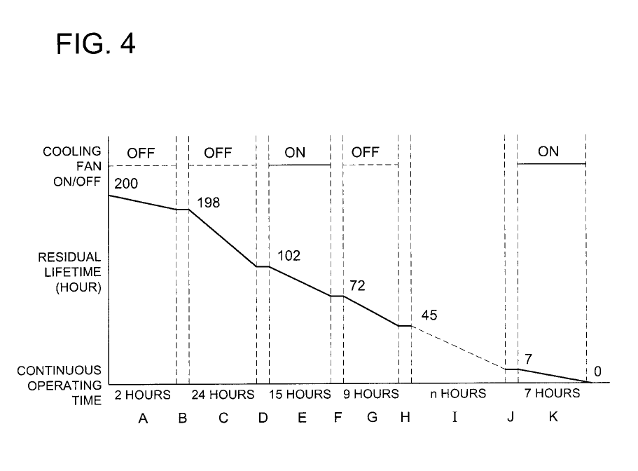

FIG. 4 is a drawing representing an example of the HDD operating conditions.

Referring to FIG. 4, the following describes the change in the residual lifetime due to operation, and the meaning of the aforementioned formula for calculating the residual lifetime T, regarding the HDD having a residual lifetime of 200 hours when power has been turned on, for example.

The letters A, C, E, G, I, and K indicate the portions of the HDD performing continuous operations. A is a first continuous operation section, C is a second continuous operation section, E is a third continuous operation section, G is a fourth continuous operation section, I is a n-th continuous operation section and K is a (n+1)-th continuous operation section. Letters B, D, F, H and J show the portions of the HDD which are not operating.

In the first continuous operation section A, the cooling fan is turned off while an electrical current is applied continuously for two hours. Thus, the lifetime shortened factor is assumed to be 1, and the apparent operation time of the first continuous operation section A is (2 hours×1=) 2 hours. The residual lifetime upon completion of the operation of the first continuous operation section A (i.e., after the lapse of two hours) is 198 hours.

In the second continuous operation section C, the cooling fan is turned off while an electrical current is applied continuously for 24 hours. Thus, the lifetime shortened factor is assumed to be 4, and the apparent operation time of the second continuous operation section C is (24 hours×4=) 96 hours. The residual lifetime upon completion of the operation of the second continuous operation section C (i.e., after the lapse of 26 hours) is 102 hours.

In the third continuous operation section E, the cooling fan is turned on while an electrical current is applied continuously for 15 hours. Thus, the lifetime shortened factor is assumed to be 2, and the apparent operation time of the third continuous operation section E is (15 hours×2=) 30 hours. The residual lifetime upon completion of the operation of the third continuous operation section E (i.e., after the lapse of 41 hours) is 72 hours.

In the fourth continuous operation section G, the cooling fan is turned off while an electrical current is applied continuously for nine hours. Thus, the lifetime shortened factor is assumed to be 3, and the apparent operation time of the fourth continuous operation section G is (9 hours×3=) 27 hours. The residual lifetime upon completion of the operation of the fourth continuous operation section G (i.e., after the lapse of 50 hours) is 45 hours.

In the n-th continuous operation section I, the operation continues for “n” hours, and residual lifetime is seven hours upon completion of the operation of the n-th continuous operation section I.

In the (n+1)-th continuous operation section K, the cooling fan is turned on while an electrical current is applied continuously for 7 hours. Thus, the lifetime shortened factor is assumed to be 1, and the apparent operation time of the (n+1)-th continuous operation section K is (7 hours×1=) 7 hours. The residual lifetime upon completion of the operation of the (n+1)-th continuous operation section K (i.e., after the lapse of 57+n hours) is 0 hour.

The alarming section 104 issues an alarm about the lifetime of the HDD 214 based on the residual lifetime of the HDD calculated by the CPU 10, when the residual lifetime has been reduced to 0 hour or less.

The aforementioned arrangement makes it possible to calculate the accurate residual lifetime with consideration given to the lifetime shortened by HDD continuous operation and to output an error alarm in the image forming apparatus in response to the residual lifetime of the HDD. This arrangement enables the HDD to be replaced before an error relating to the HDD lifetime occurs, and avoids an unexpected trouble related to the HDD lifetime and possible loss caused by system down.

Further, since accurate prediction of the HDD residual lifetime can be achieved, avoided is replacement of the HDD that can still be used, and saves the unnecessary labor and cost.

The following describes an embodiment of alarming relating to the lifetime of the HDD 214 in cases where the cooling fan for cooling the HDD is turned-on or off.

The CPU 10 measures the cooling time in which the cooling fan is turned on during the continuous operation of the HDD 214, and non-cooling time in which the cooling fan is turned off during the continuous operation.

The CPU 10 reads out the shortened lifetime information table containing the description of the shortened lifetime information for the continuous operation time with consideration given to cooling, and obtains the non-cooling time lifetime shortened factor α in cases where the cooling fan 216 does not cool the HDD during the continuous operation of the HDD 214, and lifetime shortened factor β in cases where the cooling fan 216 cools the HDD.

Based on the non-cooling time lifetime shortened factor α, non-cooling time, cooling lifetime shortened factor β and cooling time, the CPU 10 calculates the residual lifetime of the HDD 214.

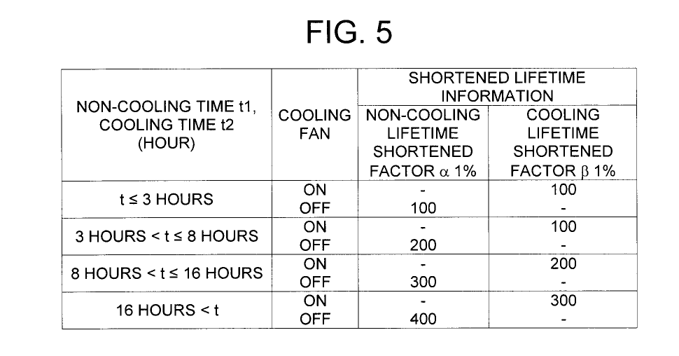

FIG. 5 is a conceptual diagram showing the shortened lifetime information table describing the shortened lifetime information with respect to the continuous operation time with consideration given to the cooling of the HDD.

The shortened lifetime information table (FIG. 5) is stored in the ROM 12. For example, if the HDD is operated on a continuous basis for 16 hours or more without interruption when the cooling fan is turned off and hence the HDD is not cooled, the temperature will rise to approximately 50 degrees Celsius, and the lifetime shortened factor will be 4, as shown in this Table. The Table also shows that, as a result, the HDD having a lifetime of 20,000 hours will have its residual lifetime reduced down to zero (0) after 5,000 hours operation. Thus, if the HDD having a lifetime of 20,000 hours continues to be used under this operation condition, the residual lifetime is reduced down to zero (0) after 5,000 hours operation.

The residual lifetime can be calculated by the following formula, assuming that residual lifetime is T (hours), HDD lifetime is TL (hours) (in the case of continuous operation, residual lifetime when power is turned on), the number of times of a plurality of continuous operations is n, the non-cooling time during each of n-th continuous operations is t1ₙ (hour), the lifetime shortened factor for the non-cooling time corresponding to each of non-cooling times is α1ₙ, each cooling time during each of n-th continuous operations is t2ₙ (hour), and the lifetime shortened factor for the cooling time corresponding to each of non-cooling times is β1ₙ.

Residual lifetime T=lifetime TL−Σₙ₌₁ⁿ{(non-cooling time t1n×non-cooling lifetime shortened factor α1ₙ)+(cooling time t2ₙ×cooling lifetime shortened factor β1ₙ)}

The alarming section 104 issues an alarm about the lifetime of the HDD 214 when the residual lifetime of the HDD calculated by the CPU 10 has reduced to 0 or less than 0 hour.

The aforementioned arrangement enables to calculate more accurate residual lifetime with consideration given to the influence of the presence or absence of HDD cooling, as well as the shortening of the lifetime by the HDD continuous operation. It also allows outputting of the error alarm of the image forming apparatus in response to the residual lifetime of the HDD. Thus, this arrangement allows the HDD to be replaced before an error relating to the HDD lifetime occurs, and to avoid an unexpected trouble related to the HDD lifetime and possible loss caused by system down.

The following describes an example of measuring the aforementioned continuous operation time and the cooling time to be controlled by the CPU 10.

In the first place, the following describes the case of measuring the continuous operation time.

When an access is generated to the HDD 214 for image information and others, the CPU 10 gives an instruction to the HDD controller 204 to store and readout the data. Then the HDD controller 204 allows the HDD 214 to transfer the data in response to the instruction.

When there is no transfer of data, the HDD 214 automatically stops the motor and retracts the head. In this case, to avoid wear of the parts, the CPU 10 gives an instruction to stop the motor and to retract the head after a lapse of a predetermined time upon completion of access to data.

As described above, the CPU 10 controls the HDD 214 through the HDD controller 204. Thus, the CPU 10 can get accurate information on the HDD 214 operation status by referring to its own clock, and this arrangement ensures accurate measurement of the continuous operation time of the HDD 10.

The following describes the measurement of the cooling time:

The CPU 10 controls the cooling fan 216 through the cooling fan controller 203 and measures the continuous operation time as described above. This arrangement provides accurate information on the on-off status of the cooling fan 216 during the continuous operation, and allows the CPU 10 to make an accurate measurement of the non-cooling time and cooling time by reference of its own clock.

The following describes other alarms relating to the lifetime:

As described above, the temperature of the HDD is raised by continuous operation. The temperature rise accelerates the wear of the motor shaft, with the result that the HDD lifetime is shortened.

Thus, the residual lifetime can be calculated according to the HDD temperature or the temperature in the vicinity of the HDD, and an alarm can be issued thereafter.

In this case, residual lifetime is calculated, with consideration given to the shortened lifetime information table (FIG. 5).

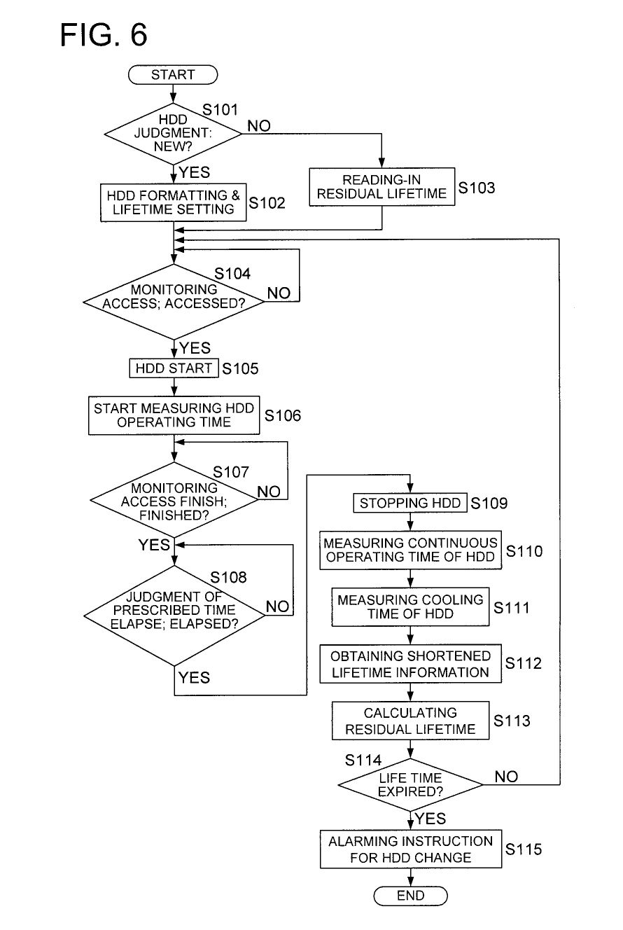

FIG. 6 is a flow chart representing the method of issuing an alarm about the HDD lifetime in the image forming apparatus.

The following describes the method of issuing an alarm about the lifetime of the HDD of the image forming apparatus by referring to the flow chart, based on the continuous operation time with consideration given to the cooling the HDD.

Unless otherwise specified, the following control is conducted by the CPU 10 of the image forming apparatus.

1. Evaluation of HDD: The CPU 10 monitors the main power source of the image forming apparatus 1. If the main power source is turned on, the CPU 10 determines if the HDD 214 connected is a new HDD or not. If it is new (YES), the system goes to the Step S102. If a used HDD is utilized continuously (NO), the system jumps to the Step S103 (Step S101).

2. HDD formatting: If the HDD is new, the HDD 214 is formatted and the data on lifetime set on an operation panel (not illustrated) and others is stored in the RAM (Step S102).

3. Reading of residual lifetime: If the HDD is a used one (to be used continuously without being replaced by a new one), CPU 10 reads the residual lifetime stored in the RAM 11, and allows it to be stored in the RAM as the virtual lifetime information (Step S103).

4. Monitoring of access: The CPU 10 monitors reception of image information from the network controller 205 and document image reading by the reading section 211. When the reception of image information or the document image reading has been monitored, the CPU 10 accesses the HDD to store the image information in the HDD 214. If this access has occurred or access from other position has occurred (YES), the system goes to the Step S105. If not (NO), the CPU 10 continues monitoring (Step S104).

5. Start of HDD: The HDD 214 is started by the access (Step S105).

6. Start of measuring the HDD operation time: Measurement of the continuous operation time of the HDD 214 is started by the access (Step S106).

7. Monitoring of completion of access: The CPU 10 monitors the reception by the network controller 205 and the reading of the document image by the image reading section 211. The access to the HDD completes when there is no more reception, reading or access to the HDD from other position. When access has completed (YES), the system goes to the Step S108. If not (NO), monitoring continues (Step S107).

8. Determination of elapse of a predetermined time: When a preset time has elapsed upon completion of the access (YES) the system goes to the Step S109. If not (NO), the system waits for the elapse of that time (Step S108).

9. Stop of the HDD: The HDD 214 is stopped after the lapse of a predetermined time (Step S109).

10. Measurement of HDD continuous operation time: The CPU 10 measures the continuous operation time from the start to the stop of the HDD 214 (Step S110).

11. Measurement of cooling time: The CPU 10 measures the non-cooling time in which cooling fan 216 is not cooling the HDD 214 during the continuous operation of the HDD 214 and the cooling time in which cooling fan 216 is cooling the HDD 214, and stores the result of measurement into the RAM11 (Step S111).

12. Obtaining the shortened lifetime information: The CPU 10 reads and obtains the shortened lifetime information table (FIG. 5) containing the information on the shortened lifetime information with respect to the HDD continuous operation time stored in advance in the ROM12 with consideration given to the cooling (Step S112).

13. Calculation of residual lifetime:

Based on the lifetime stored in the Step S102 or the virtual lifetime stored in the Step S103, the non-cooling time and cooling time and the shortened lifetime information, the CPU 10 calculates the residual lifetime of the HDD 214, and stores the result of calculation in the RAM11 (Step S113).

The residual lifetime stored here is read in the Step S103.

The following describes the formula for calculating the residual lifetime:

Residual lifetime T=lifetime TL−Σₙ₌₁ⁿ{(non-cooling time t1ₙ×non-cooling lifetime shortened factor α1ₙ)+(cooling time t2ₙ×cooling lifetime shortened factor β1ₙ)}:

wherein the residual lifetime is T (hours), HDD lifetime is TL (hours) (in the case of continuous operation, residual lifetime when power is turned on), the number of times of a plurality of continuous operations is n, each non-cooling time during each of n times continuous operations is t1n (hour), the lifetime shortened factor for the non-cooling time corresponding to each of non-cooling times is α1ₙ, each cooling time during each of n times continuous operations is t2ₙ (hour), and the lifetime shortened factor for the cooling time corresponding to each of non-cooling times is β1ₙ.

14. Expiration of lifetime: The CPU 10 allows the alarming section 104 to check whether or not the calculated residual lifetime of the HDD has been reduced to zero or less than 0 (0 or negative value). If the monitored result has been reduced to zero or less than 0 (YES), the lifetime is determined to have expired, and the system goes to the Step S114. If the calculated residual lifetime is more than 0 (NO), the lifetime is determined not to have expired, and the system jumps to the Step S104, and calculation of the residual lifetime is repeated until the value is reduced to zero or less than 0 (Step S114).

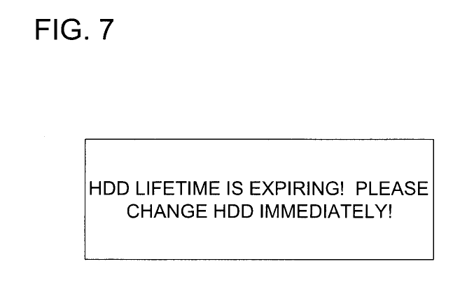

FIG. 7 is a drawing showing an example of an alarm about the HDD lifetime.

15. HDD replacement instruction alarm: Since the HDD lifetime has expired, an alarm about the HDD replacement instruction as shown in FIG. 7 is given on the operation panel (not illustrated) and others of the image forming apparatus (Step S115).

The aforementioned arrangement ensures calculation of more accurate residual lifetime with consideration given to the influence of the presence or absence of HDD cooling, as well as the shortening of the lifetime by the HDD continuous operation. It also ensures outputting of the error alarm of the image forming apparatus in response to the residual lifetime of the HDD. Thus, this arrangement enables the HDD to be replaced before an error affecting the HDD lifetime occurs, and avoids an unexpected trouble related to the HDD lifetime and possible loss caused by system down.

Further, since accurate prediction of the HDD residual lifetime can be achieved, avoided is replacement of the HDD that can still be used, and saves the unnecessary labor and cost.

The above description refers to the method of issuing an alarm about the replacement of the HDD used in the image forming apparatus, based on the continuous operation time with consideration given to the HDD cooling. Needless to say, it is possible to adopt the method of issuing an alarm about the replacement of the HDD of the image forming apparatus, simply based on the HDD continuous operation time. In this case, the residual lifetime is calculated according to the following formula, referring to the shortened lifetime information table (FIG. 3):

Residual lifetime T=lifetime TL−Σₙ₌₁ⁿ(continuous operation time tₙ×lifetime shortened factor αₙ)

What is claimed is:

1. An image forming apparatus comprising:
an image forming section which forms an image based on image information;
an HDD which stores the image information;
a control section which measures continuous operation time in which the HDD operates continuously, and calculates residual lifetime of the HDD based on the continuous operation time having been measured and information of shortened lifetime caused by continuous operation; and
an alarming section which issues an alarm based on the residual lifetime of the HDD.

2. The image forming apparatus of claim 1, wherein the control section calculates the residual lifetime by utilizing a formula of:
T=TL−Σₙ₌₁ⁿ(tₙ×αₙ)
where, T is residual lifetime (hours), TL is HDD lifetime (hours), n is number of times of a plurality of continuous operations of the HDD, tn is continuous operation time for each of “n” times continuous operations (hours), and αₙ is a lifetime shortened factor for each of “n” times continuous operations.

3. An image forming apparatus comprising:
an image forming section which forms an image based on image information;
an HDD which stores the image information;
a cooling device which cools the HDD;
a control section which measures continuous operation time in which the HDD operates continuously, non-cooling time during which the cooling device does not cool the HDD in the continuous operation time, and cooling time during which the cooling device cools the HDD in the continuous operation time, which obtains non-cooling time shortened lifetime information corresponding to the non-cooling time, and cooling time shortened lifetime information corresponding to the cooling time, and which calculates residual lifetime of the HDD based on the non-cooling time, non-cooling time shortened lifetime information, cooling time, and cooling time shortened lifetime information; and
an alarming section which issues an alarm based on the calculated residual lifetime of the HDD.

4. The image forming apparatus of claim 3, wherein the control section calculates the residual lifetime by utilizing a formula of:
T=TL−Σₙ₌₁ⁿ{(t1ₙ×α1ₙ)+(t2ₙ×β1ₙ)}
where, T is the residual lifetime (hours), TL is HDD lifetime (hours), n is number of times of a plurality of continuous operations of the HDD, t1ₙ is each non-cooling time in each of “n” times continuous operations (hours), α1ₙ is a lifetime shortened factor corresponding to the non-cooling time t1ₙ, t2ₙ is each cooling time in each of “n” times continuous operations (hours), and β1ₙ is a lifetime shortened factor corresponding to the cooling time t2ₙ.

5. The image forming apparatus of claim 1, further comprising a communication section which obtains the image information from an external terminal, wherein the image information is stored in the HDD.

6. The image forming apparatus of claim 3, further comprising a communication section which obtains the image information from an external terminal, wherein the image information is stored in the HDD.
